(19) United States
(12) Patent Application Publication
(10) Pub. No.: US 2004/0112630 A1
(43) Pub. Date: Jun. 17, 2004

(54) Sound signal wire and process for enhancing rigidity thereof

(75) Inventor: Joseph Ko, Taipei (TW)

Correspondence Address: SHOEMAKER AND MATTARE, LTD, P.O. BOX 2286, 2001 JEFFERSON DAVIS HIGHWAY, ARLINGTON, VA, 22202-0286, US

(73) Assignee: Taiwan Maeden Co., Ltd., Taipei (TW)

(21) Appl. No.: 10/318,007

(22) Filed: Dec. 13, 2002

(51) Int. Cl. H01B 5/00

(52) U.S. Cl. 174/126.1; 174/128.1

(57) ABSTRACT

A sound signal wire is provided, which is composed of two sets of weaving wires, wherein the first set of weaving wires are positioned at a central portion of the sound signal wire to serve as a main support for the sound signal wire, and the second set of weaving wires are positioned at a peripheral portion of the sound signal wire and rotationally woven to encompass the first set of weaving wires. This sound signal wire has better flexibility and greater tensile strength, and thereby is not easily subject to roping effect during vibration, making the sound signal wire particularly suitable for transmitting sound signals in a speaker.

### FIELD OF THE INVENTION

The present invention relates to sound signal wires, and more particularly, to a sound signal wire having better flexibility and greater tensile strength to prevent roping effect from occurrence, thereby making the sound signal wire suitably used in a speaker for transmitting sound signals.

### BACKGROUND OF THE INVENTION

Generally, a speaker is composed of a speaker frame, a diaphragm, a damper, sound signal wires, a magnetic circuit, a voice coil bobbin, and a voice coil surrounding the voice coil bobbin. A sound signal is transmitted in the form of current via the sound signal wires from a signal input port externally connected to the speaker frame to the voice coil where a magnetic field can be produced; then, attraction and repulsion generated between the magnetic field and the magnetic circuit allows the diaphragm to vibrate and produce sound. The speaker is usually provided with two sound signal wires, each wire having one end fixed to the speaker frame and penetrating the diaphragm to couple to the voice coil, and the other end of the wire is coupled to the signal input port externally connected to the speaker frame. The sound signal wires vibrate vertically along with vibration of the diaphragm to produce sound from the speaker; when the sound signal exceeds a certain frequency, besides vertical vibration, the sound signal wires would also vibrate horizontally or induce rippling vibration, customarily referred to as roping effect. The roping effect of the sound signal wires may disturb the diaphragm or damper to produce noise, and may also make the sound signal wires come into contact with each other to form short-circuiting of the sound signal. Moreover, if the sound signal wires are not fabricated with sufficient tensile strength, wire vibration may lead to cracks of the sound signal wires. Therefore, how to effectively increase tensile strength of a sound signal wire to prevent roping effect has become an important subject for improving quality of a speaker in the industry.

In order to eliminate the roping effect, Taiwan Patent No. 087220313 discloses a modified damper of a speaker, wherein a conductive metal layer is coated by a vacuum electroplating process over an upper-end surface and a lower-end surface of the damper, allowing the conductive metal layer to replace a conventional sound signal wire to be electrically connected to a voice coil, so as to prevent the roping effect and noise from occurrence. Moreover, U.S. Pat. No. 5,125,473 discloses another damper of the speaker, wherein a sound signal member for transmitting sound signals is fixed to the damper, thereby preventing cracks of the sound signal member with inadequate tensile strength. The foregoing arrangement of coating the conductive metal layer on the damper and fixing the sound signal member on the damper would make fabrication processes more complicated and cost-ineffective to implement; operational inaccuracy or imprecision may easily degrade transmission quality of sound signals, and undesirably increases complexity in fabrication.

A currently-used sound signal wire for sound-signal transmission in a speaker is formed by weaving from weaving wires or winding litz wires, wherein each of the weaving wires or litz wires is composed of an inner fiber and a conductive metal part encompassing the inner fiber. Moreover, the sound signal wire formed by winding the litz wires is relatively of low rigidity, whereas the sound signal wire fabricated by rotationally weaving from the weaving wires is better in rigidity but poor in flexibility, which makes the sound signal wire easily subject to roping effect by high-frequency vibration.

In light of the shortcomings discussed above, a modified weaving method is provided here to produce a sound signal wire having better flexibility without having to perform complicated fabrication processes. This sound signal wire eliminates the occurrence of roping effect during high-frequency vibration, and therefore is suitably applied to a speaker.

### SUMMARY OF THE INVENTION

An objective of the present invention is to provide a sound signal wire, which has better flexibility and eliminates the occurrence of roping effect at high-frequency vibration. This sound signal wire is fabricated by a modified weaving method and composed of two sets of weaving wires, wherein the first set of weaving wires form a central portion of the sound signal wire, and the second set of weaving wires form a peripheral portion of the sound signal wire and are rotationally woven to encompass the first set of the weaving wires.

Another objective of the invention is to provide a sound signal wire, which has greater tensile strength and an inner fiber part thereof being made of a super heat resistant fiber formed by mixed-weaving a poly para-aramid fiber and a poly meta-aramid fiber.

A further objective of the invention is to provide a method for increasing rigidity of a sound signal wire, which method involves coating of the sound signal wire with a solution of acetal resin.

In accordance with the above and other objectives, the present invention proposes a sound signal wire composed of two sets of weaving wires, wherein the first set of weaving wires are positioned at a central portion of the sound signal wire to serve as a main support for the sound signal wire, and the second set of weaving wires are positioned at a peripheral portion of the sound signal wire and rotationally woven to encompass the first set of weaving wires. This sound signal wire has better flexibility and greater tensile strength, and thereby is not easily subject to roping effect during vibration, making the sound signal wire particularly suitable for transmitting sound signals in a speaker.

### DETAILED DESCRIPTION OF THE PREFERRED EMBODIMENTS

Generally, a sound signal wire for sound-signal transmission in a speaker is formed by weaving from weaving wires or winding litz wires, wherein each of the weaving wires or litz wires is composed of an inner fiber and a conductive metal part encompassing the inner fiber.

A sound signal wire fabricated by a conventional weaving method may usually have 8 strands, 12 strands, 16 strands, 20 strands and 24 strands of weaving wires depending on a model of a weaving machine. For example, a 8-strand sound signal wire is fabricated by a rotationally weaving process through the use of a weaving machine with 8 rollers, wherein the rollers are arranged in a circle, and each roller is wound with a strand of wire in a circle track to perform the rotationally weaving process, so as to form the sound signal wire having 8 strands of the weaving wires. Similarly, a sound signal wire with 12, 16, 20 or 24 strands of weaving wires is fabricated by using a weaving machine with 12, 16, 20 or 24 rollers, respectively.

A conventional weaving machine can be utilized in the invention; for example of a weaving machine with 8 circularly-arranged rollers, 8 strands of weaving wires are wound respectively on the 8 rollers and rotate along with the rollers to perform the rotationally weaving process, and at the center encompassed by the 8 circularly-arranged rollers there are provided another set of weaving wires as a main support for said sound signal wire. The 8 strands of weaving wires are rotationally woven to form a set of weaving wires (hereinafter referred to as a second set of weaving wires), which encompass the centrally-situated weaving wires (hereinafter referred to as a first set of weaving wires), so as to form a sound signal wire according to the present invention. Therefore, the above-fabricated sound signal wire is composed of two sets of weaving wires, wherein the first set of weaving wires form a central portion of the sound signal wire, and the second set of 8 strands of weaving wires form a peripheral region of the sound signal wire and are rotationally woven to encompass the first set of weaving wires, such that the sound signal wire according to the present invention can be formed.

Similarly, in the use of a conventional weaving machine with 12, 16, 20 or 24 circularly-arranged rollers, a second set of 12, 16, 20 or 24 strands of weaving wires are wound respectively on the rollers, and a first set of weaving wires are provided at the center encompassed by the circularly-arranged rollers to thereby produce a sound signal wires according to the present invention. It should be understood that, the sound signal wire of the invention is not limited to the foregoing number of weaving wires; in other words, the first and second sets of weaving wires of the sound signal wire may be adjusted in strand number thereof depending on practical requirements.

Therefore, the sound signal wire according to the invention can be fabricated by a modified weaving method through the use of the conventional weaving machine, without having to perform complicated fabrication processes. This sound signal wire is composed of two sets of weaving wires; compared to a conventional sound signal wire fabricated by winding weaving wires along a circle track on rollers of a weaving machine, the sound signal wire according to the invention has a first set of weaving wires centrally situated as a main support, thereby making the sound signal wire have better flexibility and not easily subject to roping effect under high-frequency vibration, such that the sound signal wire is particularly suitable for transmitting sound signals in a speaker.

Moreover, the sound signal wire can be made of a textile material serving as an inner fiber of the sound signal wire, wherein the textile material includes cotton fiber, rayon fiber, poly-ester fiber, poly-aramid fiber, and so on. Among the above poly-aramid fibers, poly meta-aramid fibers have high melting point, high rigidity and stable size, and usually serve as retardant fibers that are resistant to a high-temperature environment produced by high-frequency vibration in the speaker. In another aspect, poly para-aramid fibers have great tensile strength, durability, resistance to chemicals and shock absorbability; they can be used as bulletproof fibers for manufacturing bulletproof vests, bulletproof helmets and anti-explosion equipment. Although many types of poly aramid fibers have been used to make an inner fiber of the conventional sound signal wire, only a single poly para-aramid fiber or poly meta-aramid fiber is employed each time.

The present invention also provides a strong heat-resistant fiber made by mixed-weaving poly para-aramid fiber and poly meta-aramid fiber, so as to serve as the textile material for fabricating the inner fiber of the sound signal wire. Compared to the conventional sound signal wire made of a single type of poly meta-aramid fiber, the sound signal wire fabricated by this strong heat-resistant fiber is resistant to heat/high temperature and has greater tensile strength and flexibility, to thereby suitably applied to the speaker for preventing the roping effect and cracks of the sound signal wire due to vibration.

Furthermore, a process for increasing rigidity of the sound signal wire is provided, in which a solution of acetal resin is coated on the sound signal wire, the solution of acetal resin has excellent adhesion and transparency to be used as an adhesive or coating material. It is found that the solution of acetal resin formed by dissolving acetal resin in a suitable solvent can be coated on the sound signal wire to effectively increase wire rigidity, making the sound signal wire not easily subject to the roping effect by high-frequency vibration.

There is no particular limitation on the solvent for diluting acetal resin, and any solvent that dissolves acetal resin may be used; an alcoholic solvent is normally preferable, such as (but not limited to) methanol, ethanol, propanol, iso-propanol, and so on. The solution of acetal resin may be coated on the sound signal wire by any suitable method, such as dipping, spraying, applying, and so on. The solution of acetal resin may be further added with a variety of additives, including phosphate ester such as TBP or TCP, phthalate ester such as DOP, DPB, and BBP, polyethylene glycol, triethylene glycol di-butyrate, Castor oil, and so on, to modify resin characteristics; these additives may be selected and added to the solution of acetal resin by persons skilled in the art depending on practical requirements.

The features and improvements of the sound signal wire according to the invention can be more fully understood by the following description with reference to preferred embodiments below.

### PREFERRED EMBODIMENTS

### PREPARATION EXAMPLE 1

Poly meta-phendioyl meta-phenylene diamide is used as a textile material for an inner fiber; the inner fiber is made with its specification of a 40-in-2 strand and encompassed by a single sheet of copper foil coated with silver to form a litz wire. Then, 7 strands of the litz wires are wound to be subject to anti-oxidation treatment at 82° C. to form Sample 1 of the sound signal wire.

### PREPARATION EXAMPLE 2

The above process of Preparation Example 1 is similarly performed for forming Sample 2 of the sound signal wire except that the inner fiber is encompassed by two sheets of copper foil coated with silver to form the litz wire.

### PREPARATION EXAMPLE 3

The above process of Preparation Example 2 is similarly performed for forming Sample 3 of the sound signal wire except that the inner fiber is made with its specification of a 30-in-3 strand.

### PREPARATION EXAMPLE 4

The above process of Preparation Example 3 is similarly performed for forming Sample 4 of the sound signal wire except that 4 strands of the litz wires are wound.

### PREPARATION EXAMPLE 5

Poly meta-phendioyl meta-phenylene diamide and poly para-phendioyl para-phenylene diamide are used as the textile material of the inner fiber, which is made with its specification of a 40-in-2 strand and encompassed by a single sheet of copper foil coated with silver to form a litz wire. Then, 7 strands of the litz wires are wound to be subject to anti-oxidation treatment at 82° C. to form Sample 5 of the sound signal wire.

### PREPARATION EXAMPLE 6

The above process of Preparation Example 5 is similarly performed for forming Sample 6 of the sound signal wire except that the inner fiber is encompassed by two sheets of copper foil coated with silver to form the litz wire.

### PREPARATION EXAMPLE 7

The above process of Preparation Example 6 is similarly performed for forming Sample 7 of the sound signal wire except that the inner fiber is made with its specification of a 30-in-3 strand.

### PREPARATION EXAMPLE 8

The above process of Preparation Example 7 is similarly performed for forming Sample 8 of the sound signal wire except that 4 strands of the litz wires are wound.

Samples 1 to 8 of the sound signal wire produced respectively by Preparation Examples 1 to 8 are subject to tests for tensile strength, flexibility and conductivity, with test results being shown in Table 1 below.

TABLE 1

| | Break Load Unit: | Flex Life at 270 | Conductor Resistance |
|---|---|---|---|
| No. | meter (Kgs) | (times) | (Ohm/meter) |
| 1 | 8.53 | 43,806 | 0.8245-0.8292 |
| 2 | 8.22 | 71,911 | 0.4474-0.4526 |
| 3 | over 10 | 118,878 | 0.5495-0.5600 |
| 4 | 8.93 | 71,555 | 1.0365-1.0502 |
| 5 | 10.52 | 183,898 | 0.7278-0.7385 |
| 6 | 10.06 | 190,558 | 0.3952-0.3975 |
| 7 | 16.00 | 363,963, | 0.4481-0.4733 |
| 8 | 12.56 | 190,777 | 0.8242-0.8477 |

As shown in Table 1, the sound signal wire made of a strong heat-resistant fiber that is fabricated by mixed-weaving poly meta-aramid fiber and poly para-aramid fiber, has greater tensile strength and better flexibility than the conventional sound signal wire formed by a single type of poly meta-aramid fiber.

### COMPARATIVE EXAMPLE 1

Poly meta-phendioyl meta-phenylene diamide and poly para-phendioyl para-phenylene diamide are used as the textile material of the inner fiber, which is made with its specification of a 40-in-2 strand and encompassed by cadmium/copper alloy to form a weaving wire. Then, 12 strands of the weaving wires are rotationally woven by using a weaving machine having 12 rollers in a manner that 12 strands of the weaving wires rotate in a circle track along with 12 rollers respectively; subsequently the weaving wires are subject to anti-oxidation at 82° C. to form Sample 9 of the sound signal wire with 12 strands of weaving wires.

The above process is similarly performed to form a weaving wire; by using a weaving machine with 8 rollers, a set of weaving wires are placed at the center encompassed by the 8 circularly-arranged rollers, and 8 strands of the weaving wires are rotationally woven and rotate in a circle track along with the 8 rollers to thereby encompass the centrally-situated weaving wires. Then, the weaving wires are subject to anti-oxidation treatment at 82° C. to form Sample 10 of the sound signal wire.

Samples 9 and 10 are tested by vertical vibration, and test conditions and vibration results are recorded in Table 2 below; if the sample is observed to vibrate horizontally or in a rippling manner during the test, O is marked and indicates the occurrence of roping effect, or X is recorded without the occurrence of roping effect.

TABLE 2

| | | Amplitude of | |
|---|---|---|---|
| No. | Rotation Speed (rpm) | vibration (cm) | Roping effect |
| 9 | 3000 | 2 | O |
| 10 | 3000 | 1.5 | X |
| 9 | 3920 | 2.5 | O |
| 10 | 3920 | 1.8 | X |

As shown in Table 2, the sound signal wires can be fabricated by modifying the weaving process to eliminate the problem of roping effect.

### COMPARATIVE EXAMPLE 2

Poly meta-phendioyl meta-phenylene diamide and poly para-phendioyl para-phenylene diamide are used as the textile material of the inner fiber, which is made with its specification of a 40-in-2 strand and encompassed by copper foil to form a weaving wire. Then, 16 strands of the weaving wires are rotationally woven by using a weaving machine having 16 rollers in a manner that 16 strands of weaving wires rotate in a circle track along with the 16 rollers to form Sample 11 of the sound signal wire having 16 strands of weaving wires.

The above weaving process is perform to form a sound signal wire having 16 strands of the weaving wires; then, the sound signal wire is coated with a solution of acetal resin (using methanol as a solvent) to form Sample 12 of the sound signal wire.

Samples 11 and 12 are tested for their vibration by the same method described in Comparative Example 1. It is found that Sample 11 is subject to roping effect, but not for Sample 12. Therefore, it indicates that coating with the solution of acetal resin can effectively increase rigidity of the sound signal wire to prevent the occurrence of roping effect.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A sound signal wire, comprising:
a first set of weaving wires positioned at a central portion of the sound signal wire; the first set of weaving wires serving as a main support for the sound signal wire; and
a second set of weaving wires positioned at a peripheral portion of the sound signal wire, and rotationally woven to encompass the first set of weaving wires.

2. The sound signal wire of claim 1, wherein each of the weaving wires is composed of an inner fiber and a conductive metal part for encompassing the inner fiber.

3. The sound signal wire of claim 2, wherein a textile material for making the inner fiber is selected from the group consisting of cotton fiber, rayon fiber, poly-ester fiber and poly-aramid fiber.

4. The sound signal wire of claim 2, wherein the conductive metal part is made of a metallic material selected from the group consisting of copper, cadmium, tin, silver and alloy thereof.

5. The sound signal wire of claim 4, wherein the conductive metal part is coated with silver.

6. The sound signal wire of claim 4, wherein the conductive metal part is coated with tin.

7. A sound signal wire, comprising:
an inner fiber comprising a heat-resistant fiber made by a poly meta-aramid fiber mixed-woven with a poly para-aramid fiber; and
a conductive metal part for encompassing the inner fiber.

8. The sound signal wire of claim 7, wherein the sound signal wire comprises a first set of weaving wire positioned at a central portion of the sound signal wire to serve as a main support for the sound signal wire, and a second set of weaving wires positioned at a peripheral portion of the sound signal wire and rotationally woven to encompass the first set of weaving wires.

9. The sound signal wire of claim 7, wherein the sound signal wire is made by wound litz wires.

10. A process for enhancing rigidity of a sound signal wire, comprising a step of coating a solution of acetal resin on the sound signal wire.

11. The process of claim 10, wherein the solution of acetal resin further comprises an additive for enhancing plasticity.

12. The process of claim 11, wherein the additive is selected from the group consisting of phosphoric ester, para-phthalic ester, polyethylene glycol, triethylene glycol di-butyrate and Caster oil.

13. The process of claim 10, wherein the sound signal wire is composed of an inner fiber and a conductive metal part for encompassing the inner fiber.

14. The process of claim 13, wherein the inner fiber comprises a heat-resistant fiber made by a poly meta-aramid fiber mixed-woven with a poly para-aramid fiber.
